(19) United States
(12) Patent Application Publication
(10) Pub. No.: US 2003/0096196 A1
(43) Pub. Date: May 22, 2003

(54) Process for curing of a resist which has been applied to a large substrate, and device for carrying out of the process

(75) Inventors: Yoshiki Mimura, Kanagawa-ken (JP); Kazumoto Tochihara, Kanagawa-ken (JP)

Correspondence Address: NIXON PEABODY, LLP, 8180 GREENSBORO DRIVE, SUITE 800, MCLEAN, VA, 22102, US

(73) Assignee: USHIODENKI KABUSHIKI KAISHA

(21) Appl. No.: 10/300,796

(22) Filed: Nov. 21, 2002

(30) Foreign Application Priority Data
Nov. 21, 2001 (JP) 2001-356174

(51) Int. Cl. G03C 5/00

(52) U.S. Cl. 430/311; 430/330; 430/348; 430/397

(57) ABSTRACT

A process for curing of a resist in which the consumption of the device is not increased and a device for carrying out the process is achieved following manner. The workpiece stage is divided into several stages which are smaller than the size of the workpiece. The areas formed by division are each controlled to different constant temperatures. First, the part of the workpiece to which a resist has been applied and which has been developed is seated on a stage of the workpiece stage by a workpiece transport means. The resist-applied part of the workpiece is irradiated with UV radiation from a light irradiation part while it is being heated. Then, the workpiece is moved by the workpiece transport means such that the workpiece which was located on the above described stage is transported onto another stage and the other part of the workpiece is transported onto the stage named first. UV radiation is emitted from the light irradiation part. Likewise, the workpiece is irradiated with UV radiation while the workpiece is moved intermittently by the workpiece transport means. In this way the resist is cured.

### BACKGROUND OF THE INVENTION

1. Field of the Invention

The invention relates to a process for curing a resist, in which a resist, which has been applied, for example, to a wafer with a diameter of at least 300 mm or to a display substrate, such as a liquid crystal or the like, is cured by UV radiation with simultaneous heating and increasing of the temperature. The invention furthermore relates to a device for carrying out the process.

2. Description of Related Art

In the production of semiconductor ICs (in the exposure process and during the etching process), irradiating a resist pattern, which has been formed on a wafer and which has been developed, with UV radiation, with simultaneous heating and increasing of the temperature, and thus, increasing the thermal stability and etching resistance of the resist, are known (for example, Japanese patent publication HEI 4-78982 corresponding to U.S. Pat. No. 4,842,922).

If a developed resist in which a pattern is formed is heated to at least 150° C., the formed pattern loses its shape. This is called “resist flow.” When the resist flows, it can no longer be etched to the desired pattern. The temperature at which no flowing of the resist occurs is called the “thermal stability temperature” of this resist. Thermal stability of the resist after development is normally 100° C. to 110° C. In the etching process, as the following process, there are however cases in which, depending on the etching conditions, the temperature reaches at least 150° C. and in which high thermal stability is required from the resist.

If the resist is irradiated with UV radiation while gradually heating it, proceeding from the temperature at which no flow takes place, the resist acquires high thermal stability. This is called “curing of the resist” or the like. The resist is cured, for example, with the process described below.

The resist is heated to 50° C. to 100° C. at which no flow occurs. Proceeding from this state, the resist is irradiated with UV radiation with wavelengths of 220 nm to 320 nm and its temperature is continually or incrementally increased up to the setting temperature (for example, roughly 200° C. to 250° C.) which approaches the expected thermal stability temperature. When the setting temperature is reached the UV irradiation is stopped. Afterwards, cooling to 50° C. to 100° C. takes place so that transport can be carried out.

In the case of a continuous temperature increase, a rate of temperature increase of 1° C./sec to 2° C./sec to raise the heating temperature is needed. It is desirable for the rate of temperature decrease during cooling after UV irradiation to be higher in order to improve the throughput; the temperature decrease is in fact roughly 3° C./sec.

A device for curing a resist which carries out the aforementioned treatment has a workpiece stage with a temperature which can be increased or decreased in order to reliably carry out temperature control of the resist. The workpiece stage is made of metal with good thermal conductivity and holds a wafer (hereinafter also called a “workpiece”) which has a resist which is to be treated, by vacuum suction. The temperature of this secured wafer is controlled by heating this stage by means of a heater or cooling it by cooling water. Recently, the same resist curing treatment has been performed more and more often, not only in the production of semiconductor ICs, but also in pattern formations of display substrates, such as liquid crystals or the like. Therefore, not only a wafer, but also a rectangular, large substrate, is being used more and more often for the workpiece.

FIG. 5 show a workpiece stage WS which is used for a resist curing device and which holds a rectangular substrate, in an overall perspective. FIGS. 6(a) and 6(b) are each a side view of workpiece stage WS. As is shown in FIGS. 5, 6(a) & 6(b), the surface of the workpiece stage WS is provided with several vacuum suction grooves Vs which are used for vacuum suction of the workpiece and to which a vacuum is supplied. Thus, the seated workpiece is vacuum suctioned. The workpiece stage WS is made, for example, of an aluminum alloy. The side of the workpiece stage WS, as shown in FIG. 6(a), is provided with several through openings into which rod-shaped sheath heaters Ht with a length which corresponds to the length of this through opening are inserted, in the manner shown in FIG. 5. When the sheath heater Ht is supplied with electricity, the sheath parts are heated and the stage is heated by thermal conduction.

The through openings into which the heaters are inserted and the inside of the stage between the through openings are provided with water supply lines F1 through which in the workpiece stage WS cooling water for cooling flows, and with vacuum supply lines (not shown in the drawings) which supply the vacuum to the vacuum suction grooves Vs. The water supply lines F1, via which the cooling water flows, are connected to one another on the bottom of the workpiece stage WS by bridge pipe lines F2. The cooling water is delivered at two points and drains out at two points.

The workpiece to which the resist in which the pattern is formed has been applied and which was developed is placed on the above described workpiece stage WS. The workpiece is vacuum-suctioned by vacuum suction onto the workpiece stage WS. As is described, for example, in the Japanese patent publication HEI 4-78982 (U.S. Pat. No. 4,842,992) or the like, the workpiece stage WS is heated and subjected to a temperature increase by UV radiation being emitted from a light irradiation part not shown in the drawings. In this way the resist is cured.

A display substrate, as a workpiece, is becoming larger and larger from year to year. A substrate with one side from 50 cm to 1 m or more is also used. Furthermore, there is the tendency for the wafer to have a diameter of 300 mm or greater.

In the case of curing treatment of a resist in the above described large substrate, the workpiece stage which holds this substrate must be made larger according to the size of the substrate. If the workpiece stage is made larger, the thermal capacity is increased accordingly. To maintain the required rate of temperature increase (1° C./sec to 2° C./sec), the output of the heaters or the number of heaters must be increased or similar measures taken. Also, when cooling after the end of treatment, the flow amount of coolant or pressure must be increased to carry out cooling as quickly as possible. This leads to an increase in consumption and operating costs of the device.

### SUMMARY OF THE INVENTION

The invention was devised to eliminate the above described disadvantages of the prior art. Thus, a primary object of the present invention is to devise a process for curing of a resist in which even in the case of treatment of a large workpiece, such as, for example, of a large display substrate, the power to be delivered to the device is not increased if the resist is cured by UV irradiation with simultaneous heating of the workpiece to which the resist has been applied. A further object of the invention is to devise a device for executing the process.

These objects are achieved in accordance with the invention as follows:

The workpiece which is provided with a resist is transported gradually to areas with higher temperatures.

The workpiece is irradiated with UV radiation while gradually increasing the workpiece temperature, part for part. Thus, the above described resist is cured.

This means that the device is arranged in the manner described below, UV irradiation is carried out during gradual increasing of the workpiece temperature, part for part, in the manner described below in (1), and thus the resist is cured. Furthermore the workpiece is cooled in the manner described below in (2).

(1) The workpiece stage is divided into several small areas which are smaller than the size of the workpiece. These divided areas are controlled each to different constant temperatures and are arranged along the transport direction of the workpiece such that the temperature gradually increases. The workpiece is irradiated with UV radiation by the workpiece being moved gradually by a transport means part for part to the areas with different temperatures of the workpiece stage. This means that the inside of the same workpiece is treated by using different temperatures (the respective temperature is however constant).

(2) following step (1), in the workpiece stage, on a side which is located farther downstream of the transport direction of the workpiece than the area with the highest temperature, there is an area with a low temperature. The workpiece in which the UV irradiation has been completed is gradually transported to the area with the low temperature which is located downstream and the workpiece is cooled.

By treating the workpiece with a constant temperature in the above described manner, the power to be delivered to the device can be reduced far more than in the case of a temperature increase or decrease of the entire workpiece stage.

If, as described above, the power consumption in the case of control of the workpiece stage at a constant temperature and the power consumption in the case of carrying out a temperature increase or decrease are computed, the power consumption in the case of carrying out a temperature increase or decrease is roughly 17 times as high as that in the case of control at a constant temperature (in the case of an aluminum workpiece stage size of 100 cm×100 cm×2 cm).

According to the invention, it is no longer necessary to rapidly reduce the stage from a high temperature to a low temperature in each treatment of the workpiece. Therefore, the flow amount and the pressure of the cooling water which is supplied to the workpiece stage can be reduced. In this way, the consumption of the device, such as the electrical power and cooling water, can be prevented from increasing.

The invention is further described below using the drawings.

### BRIEF DESCRIPTION OF THE DRAWINGS

FIG. 1 is a schematic representation of the overall arrangement of an embodiment of the device in accordance with the invention for curing the resist;

FIGS. 2(a) to 2(h) each schematically show a respective step of the sequence of resist curing steps in accordance with the FIG. 1 embodiment of the invention;

FIGS. 3(a) to 3(f) each schematically show stage in the operation of the workpiece transport device of the FIG. 1 embodiment of the invention;

FIG. 4 schematically show the workpiece stage of the FIG. 1 embodiment of the invention as viewed from the light source direction;

FIG. 5 is a perspective representation of a workpiece stage which is used for a conventional resist curing device; and

FIG. 6(a) shows a section of the workpiece stage shown in FIG. 5 and FIG. 6(b) is a sectional view of a heater cartridge of the FIG. 6 workpiece stage.

### DETAILED DESCRIPTION OF THE INVENTION

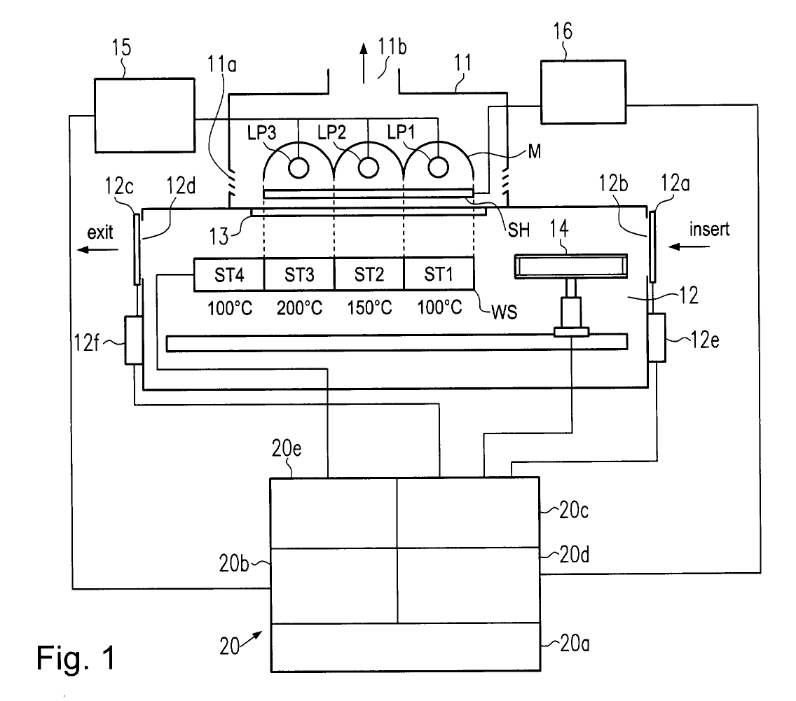

FIG. 1 shows the overall arrangement of one embodiment of a resist curing device in accordance with the invention viewed from the side. In FIG. 1, a light irradiation part 11 and a treatment chamber 12 are shown. In the light irradiation part 11, there are lamps LP1 to LP3 and mirrors M for reflecting the light from the lamps LP1 to LP3. The light irradiation part 11 and the treatment chamber 12 are separated from one another by a silica glass window 13 in which pane silica glass is installed. The lamps LP1 to LP3 are, for example, high pressure mercury lamps and emit light which contains UV radiation with wavelengths from 220 mm to 320 mm.

In the light irradiation part 11, a shutter SH for light shielding between the silica glass window 13 and the lamps LP1 to LP3 is installed with the ability to be pushed in and out. By opening the shutter SH a workpiece seated on the workpiece stage WS within the treatment chamber 12 is irradiated with UV radiation from the light irradiation part 11. By closing the shutter SH the irradiation is stopped. If the workpiece is not seated on the workpiece stage WS (for example, during transport of the workpiece), the shutter SH is blocked so that light from the lamps LP1 to LP3 is not emitted. The reason for this is the following:

If light is emitted in the state in which the workpiece is not seated on the workpiece stage WS, the energy of the emitted light and the temperature of the workpiece stage WS are increased by the radiant heat from the lamp bulb. There are cases in which, in this way, the workpiece temperature is increased and the thermal stability temperature of the resist is exceeded. This must be prevented.

Furthermore, in the light irradiation part 11, there is an inlet opening for cooling air 11a and an evacuation opening 11b. The lamps LP1 to LP3 are cooled by withdrawing air from the evacuation opening 11b by a fan (not shown).

In the treatment chamber 12, there are a workpiece stage WS which is kept in sections of different temperatures, and a workpiece transport device 14 which transports the workpiece (not shown). The surface of the workpiece stage WS, as was described above, is provided with vacuum suction grooves (not shown in the drawings) which are used for vacuum suctioning of the workpiece. A vacuum is supplied to these grooves and thus the seated workpiece is held to stage WS by suction. Furthermore, the workpiece stage WS is provided with passage grooves for workpiece transport arms (not shown in FIG. 1) through which the transport arms of the workpiece transport device 14 pass, as is described below. The material of the workpiece stage WS is, for example, an aluminum alloy, as was described above.

The workpiece stage WS, as was described above, is provided with, for example, rod-shaped cartridge heaters and with water supply lines (not shown in FIG. 1) via which the cooling water flows. The workpiece stage WS is kept in sections that are at different temperatures. In the example shown in FIG. 1, the workpiece stage WS is divided into four areas, i.e. into stage (sections) ST1 to ST4 of equal size. The stages ST1 to ST4 are kept at different constant temperatures such as, for example, the stage ST1 at 100° C., the stage ST2 at 150° C., the stage ST3 at 200° C. and the stage ST4 at 100° C. The temperature boundaries essentially orthogonally intersect the transport direction of the workpiece. The number of divisions of the workpiece stage WS is not limited to the above described 4, but can also be a different number of divisions.

Each of the lamps LP1 to LP3 is arranged in correspondence to a respective one of the stages ST1 to ST3. For example, the lamp LP1 is located to overlie the stage ST1.

The workpiece part which is seated on the stage ST1 is irradiated with UV radiation from the lamp LP1. The lamp LP2 is arranged to irradiate the stage ST2, and the lamp LP3 is arranged over the stage ST3. The stage ST4 is a stage for cooling and thus is not associated with a lamp.

The workpiece to which the resist has been applied and which has been developed transported by a workpiece transport device (not shown), after opening a shutter 12a which is located on the right side of the treatment chamber 12, is inserted through opening 12b into the treatment chamber 12. When the workpiece is transported into the treatment chamber 12, the workpiece transport device 14 transports the workpiece onto the workpiece stage WS. The surface of the workpiece stage WS is, as was described above, provided with vacuum suction grooves (not shown in the drawings) which are used for vacuum suction of the workpiece. A vacuum is supplied to these grooves and thus the workpiece is seated by suctioning.

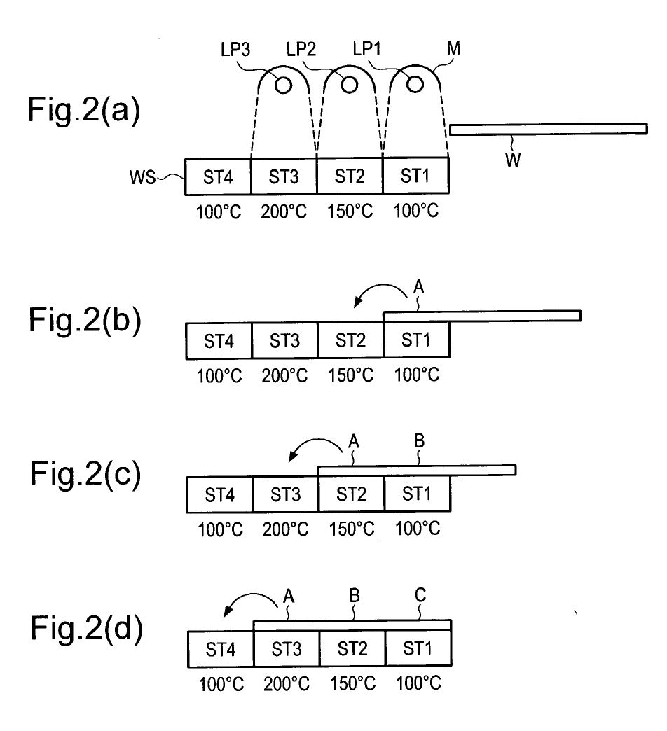

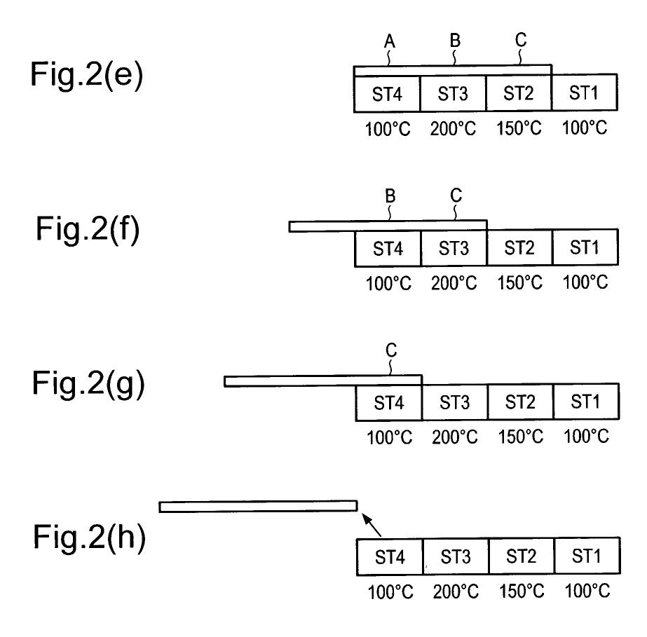

In the case shown in FIG. 1, the length of the workpiece to the left and right in the figure is identical (or longer than) to the length which is formed by adding the stages ST1 to ST3 which are opposite the lamps LP1 to LP3 of the light irradiation part 11. When the workpiece is transported into the treatment chamber 12, as is described below, first, part of the workpiece is seated on the stage ST1 (in this example, the left part of the workpiece is seated on the stage ST1) and is held by suction on the workpiece stage WS, while the remainder projects from the top of the workpiece stage WS; FIG. 2(b). The shutter SH of the light irradiation part 11 is opened and UV radiation is emitted from the lamp LP1 of the light irradiation part 11 onto the workpiece on the workpiece stage ST1.

After treatment of the workpiece for a given time by irradiating it in the above described manner with UV radiation, the vacuum suction of the workpiece is released. The workpiece transport device 14 moves the workpiece, so that the workpiece part which has been seated on the stage ST1 is moved onto the stage ST2. The not yet treated part of the workpiece is seated on the stage ST1 (in this example, the middle area of the workpiece is seated on the stage ST1) and held by vacuum on the workpiece stage; FIG. 2(c). As in the above described manner, the workpiece is treated for a given time by emitting UV radiation from the lamps LP1 and LP2. The workpiece is likewise further treated by its being moved intermittently by the workpiece stage device 14. When workpiece treatment has been completed, the shutter 12c on the left side of the treatment chamber 12 in FIG. 1 is opened and the workpiece is carried out of the treatment chamber through the opening 12d for removing the workpiece using a workpiece transport device (not shown).

The lamps LP1 to LP3 of the light irradiation part 11 are subjected to operation control by a lamp power source 15. The lamp power source 15 is comprised of power sources which subject the lamps LP1 to LP3 to operation control. Turning the lamps on and off, the luminous output and the like are controlled individually. The shutter SH of the light irradiation part 11 is driven by a device 16 for driving the shutter.

In the control device 20 there are the following components:

a controller 20a which controls overall operation of the above described resist curing device or other parts;

a lamp operation controller 20b which controls the above described lamp power source 15;

a workpiece transport device controller 20c which controls the workpiece transport device 14 and the shutters 12a, 12c of the treatment chamber;

a light irradiation part-shutter controller 20d which controls the shutter drive device which drives the shutter SH of the light irradiation part 11; and

a workpiece temperature controller 20e which controls the temperatures of the stages ST1 to ST4 of the workpiece stage WS.

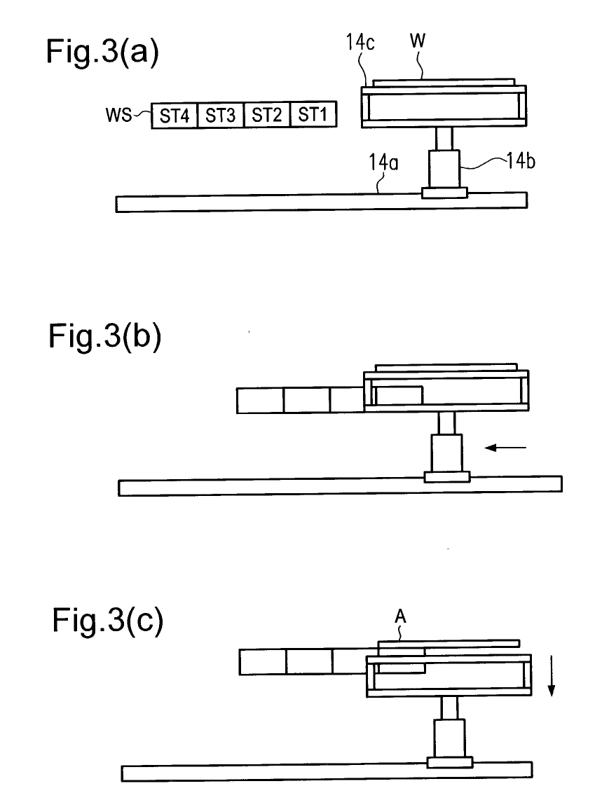

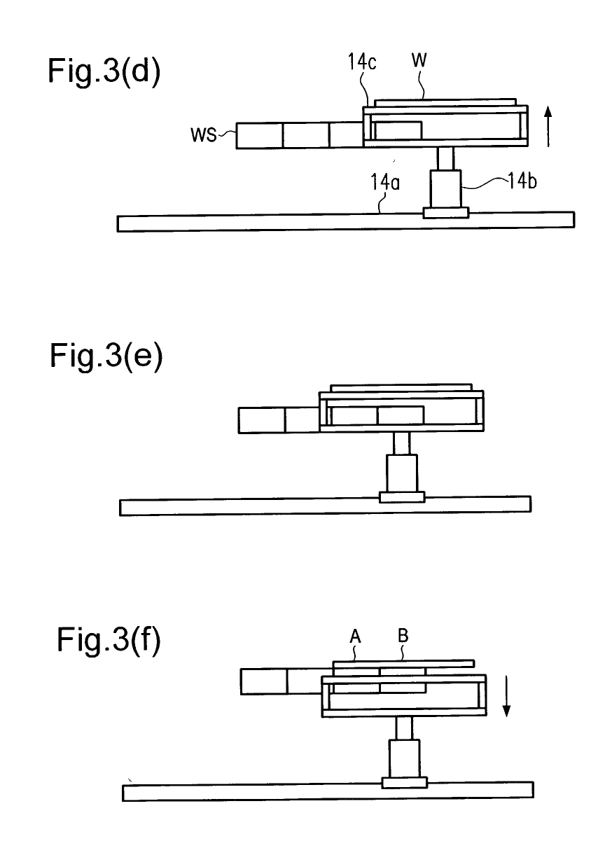

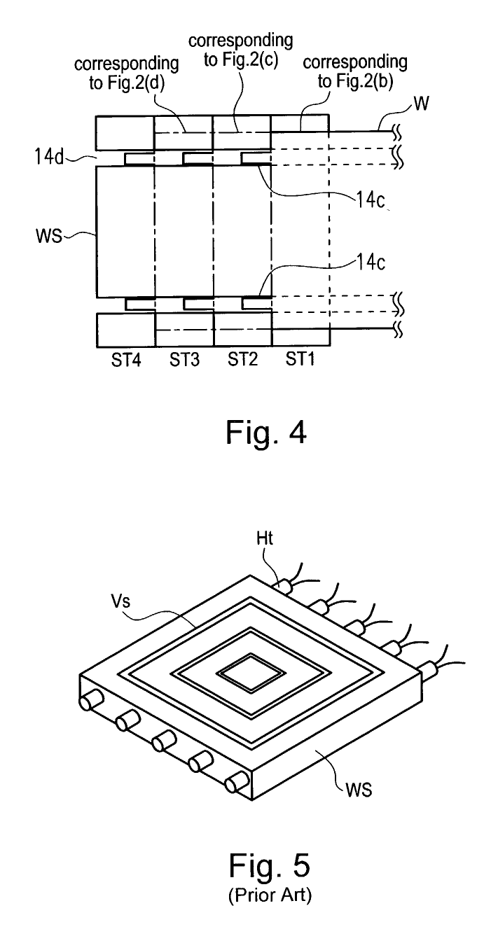

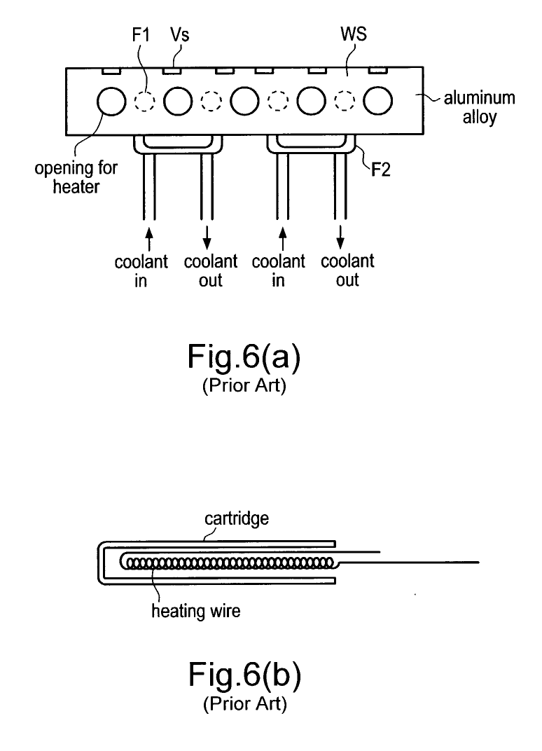

The sequence of the resist curing treatment of the invention and the workpiece transport device are described below using FIGS. 2(a) to 2(h), FIGS. 3(a) to 3(f) and FIG. 4. FIGS. 2(a) to 2(h) are side views of the device as shown in FIG. 1 and show the treatment sequence. FIGS. 3(a) to 3(f) are likewise side views and show the workpiece transport device 14 and its transport sequence.

The workpiece transport device 14 is arranged such that it moves on a rail 14a which is located along the workpiece stage WS, as is shown in FIGS. 3(a) to 3(f), and has workpiece transport arms 14c which hold the workpiece, and an air cylinder 14b which drives the workpiece transport arms 14c up and down. The workpiece transport arms 14c hold the workpiece. The rail 14a is moved and the workpiece is intermittently moved on the workpiece stage WS.

FIG. 4 is a schematic in which the workpiece stage is viewed from the light source direction (from the top). Here, the state is shown in which the workpiece W is gradually transported by the workpiece transport device 14 shown in FIGS. 3(a) to 3(c) from the stage ST1 to the stage ST4. The solid lines in FIG. 4 show the state in which the workpiece W is located at the position as shown in FIG. 2(b). The broken lines in FIG. 4 show the state in which the workpiece W is located at the positions shown in FIGS. 2(c) and 2(d).

As is shown in FIG. 4, the workpiece transport arm 14c is formed from two parallel rod-shaped components and is located at two points, i.e., at the top and bottom in the page of the drawing in FIG. 4, and furthermore to the front and back in the page of the drawings in FIGS. 3(a) to 3(f).

The workpiece stage WS is provided with workpiece transport arm passage grooves 14d through which the workpiece transport arms 14c of the workpiece transport device 14 pass. The length of one direction which orthogonally intersects the transport direction of the workpiece W is greater than the distance between the workpiece transport arms 14c. The workpiece transport arms 14c securely hold two points on the bottom of the workpiece W.

When the workpiece W is seated on the workpiece stage WS, the workpiece transport arms 14c which hold the workpiece W are positioned at given points and are moved down by the air cylinder 14b. When the workpiece W is seated on a given point of the workpiece stage WS, the workpiece W is secured by the above described vacuum suction device on the workpiece stage WS.

In the case of transport of the workpiece W to the next point, vacuum suctioning of the workpiece W is interrupted by the workpiece stage WS, the transport arms 14c are positioned at given points on the bottom of the workpiece W and are moved up by the air cylinder 14b. The workpiece W is held by the transport arms 14c and moved to the next point. FIG. 4 does not show the vacuum suction grooves and the like on the surface of the workpiece stage.

A case is described below by way of example in which the resist of the workpiece is heated from 100° C. to 200° C. by its being irradiated with UV radiation and in which it is thus cured such that it acquires a thermal stability to at least 200° C. The temperatures of the stages ST1 to ST4 which are formed by the division of the workpiece stage are identical to the temperatures described above using FIG. 1.

(1) As shown in FIG. 2(a) and FIG. 3(a), the workpiece transported into the treatment chamber 12 is seated on the workpiece transport arms 14c.

(2) As is shown in FIG. 3(b), the workpiece transport arms 14c move the workpiece W onto the stage ST1 of the workpiece stage WS. Here the lamps LP1 to LP3 are operated. The shutter SH is however closed.

(3) As is shown in FIG. 3(c), the workpiece transport arms 14c move down. In this way, as is shown in FIG. 2(b), only the area A of the workpiece W which corresponds to the length of the stage ST1 is seated on the stage ST1 and is held by vacuum suction (at the point in FIG. 4 which corresponds to FIG. 2(b)). The temperature of the stage ST1 is 100° C. This is the temperature at which an uncured resist does not flow. The shutter SH is opened. Light from the lamp LP1 is emitted onto the area A of the workpiece. The area A is treated at 100° C.

(4) The curing process of the resist of area A of the workpiece continues by this treatment. When heated to at least 100° C., for example, to roughly 150° C., at once “resist flow” no longer forms. Since this curing process is different depending on the type of resist, it is confirmed beforehand by a test.

(5) The shutter SH is closed. Vacuum suction of the workpiece stage WS is interrupted. As is shown in FIG. 3(d), the workpiece transport arms 14c move up.

(6) As is shown in FIG. 3(e), the workpiece transport arms 14c transport the workpiece W such that the area A of the workpiece W is seated on ST2 and the area B of the workpiece W is seated on ST1.

(7) The workpiece transport arms 14c move down. As is shown in FIG. 3(f) and FIG. 2(c), the workpiece W is vacuum-suctioned on the workpiece stage WS (at the point in FIG. 4 which corresponds to FIG. 2(c)). The area A of the workpiece W is heated to 150° C. If the resist has not been subjected to curing treatment, it flows when heated to 150° C. However, by means of the treatment shown above using FIG. 2(b), the area A does not immediately flow when heated to 150° C.

(8) Before the resist of area A of the workpiece W flows, the shutter SH is opened and the workpiece W is irradiated with UV radiation. The light from the lamp LP2 is emitted onto the area A of the workpiece W. At a temperature of 150° C., treatment is carried out. In this way, the curing process of area A of the workpiece W continues. Even when heated to 200° C. no “resist flow” occurs any longer. On the other hand, light from the lamp LP2 is emitted onto the area B of the workpiece W. Here, at a temperature of 100° C. treatment is carried out and curing continues as in the above described area A.

(9) The shutter SH is closed. As shown in FIG. 2(d), the area A, the area B, and the area C of the workpiece W are moved by the workpiece transport arms 14c such that the area A is seated on the stage ST3, the area B is seated on the stage ST2, and the area C is seated on the stage ST1 (at the points in FIG. 4 which correspond to FIG. 2(d)). Operation of the workpiece transport arms is identical to that as shown in FIG. 3(a) to FIG. 3(f). By treatment as shown in FIG. 2(d), the area A of the workpiece W has a thermal stability at which, even when heated to 200° C., flow does not immediately occur and the area B of the workpiece W has a thermal stability at which, even when heated to 150° C., flow does not immediately occur.

(10) Before the resist of the area A and the resist of the area B of the workpiece W begin to flow, the shutter SH is closed and the workpiece W is irradiated with UV radiation. The light from lamp LP3 is emitted onto the area A of the workpiece W, the light from lamp LP2 onto the workpiece area B, and the light from lamp LP1 is emitted onto the area C of the workpiece W. The area A of the workpiece W is treated at 200° C. The curing process is completed. The area A acquires a thermal stability to at least 200° C. Furthermore, the area B of the workpiece W acquires a thermal stability at which, even when heated to 200° C., flow does not immediately occur and the area C acquires a thermal stability at which, even when heated to 150° C., flow does not immediately occur.

(11) The shutter SH is closed. As shown in FIG. 2(e), the area A, the area B, and the area C of the workpiece W are moved by the workpiece transport arms 14c such that the area A is seated on the stage ST4, the area B is seated on the stage ST3, and the area C is seated on the stage ST2. The area A of the workpiece W is seated on the stage ST4 at a temperature of 100° C., and thus, cools.

(12) The shutter SH is opened. The workpiece W is irradiated with UV radiation. The light from lamp LP3 is emitted onto the area B of the workpiece W and the light from lamp LP2 onto the area C of the workpiece W. The curing process of area B of the workpiece W is thus completed. The area C of the workpiece W is treated at 150° C. and acquires a thermal stability at which, even when heated to 200° C., flow does not immediately occur.

(13) Then, the workpiece W is transported in the manner shown in FIGS. 2(f) and 2(g) and the areas B and C of the workpiece W are treated. In FIG. 2(f), the area B of the workpiece W is cooled. The area C is subjected to UV irradiation treatment with 200° C. In this stage, the resist curing process of the entire workpiece is completed. Then, in FIG. 2(g), the area C of the workpiece W is cooled. In this stage, cooling of the entire workpiece is completed.

(14) After completion of resist curing treatment and cooling of the entire workpiece W, the workpiece W is removed by the workpiece transport arms 14c from the workpiece stage WS as is shown in FIG. 2(h).

In this embodiment, as was described above, control is intermittently exercised such that areas A, B and C of the workpiece W are each gradually positioned in the areas of the workpiece stage WS with different temperatures. The workpiece W is irradiated with UV radiation at the respective positions. Therefore, during each treatment of the workpiece, the temperature of the stage need not be increased or it need not be lowered from a high temperature quickly to a low temperature. Therefore, the consumption of the device, such as the electrical power and cooling water, can be prevented from increasing.

In the case of controlling the workpiece stage WS at a constant temperature, and in the case of increasing or decreasing the temperature of the workpiece stage in the conventional manner, the power to be supplied to the heaters was determined; this is described below.

In the case of controlling the workpiece stage at a constant temperature, the heaters can be controlled such that only the loss of radiation emerging from the surface is balanced if convection and heat conduction are ignored, once the temperature has been reduced to the setting temperature.

In the case of constant control of the workpiece stage WS at 200° C., the power supplied to the heater was 590 W, the size of the workpiece stage WS having been 100 cm×100 cm×2 cm. The workpiece stage WS is made of aluminum. The computation was performed, the density having been 2.7 g/cm³ and the specific heat 0.937 KJ/kg.

On the other hand, in the case of raising or lowering the temperature of the workpiece stage in the conventional manner, the power supplied to the heaters for a temperature increase of 2° C./sec was 101196 W, the workpiece stage WS made of aluminum, and the size of it being identical to the above described size.

If constant temperature control is carried out, the power consumption is roughly 1/17 compared to conventional temperature increase control. In this embodiment, the power supplied to the heaters for heating the workpiece stage WS can be reduced far more than in the conventional case.

This embodiment was described using the example of a rectangular substrate. However, a circular workpiece, such as a wafer, can be transported and treated in the same way.

The stage ST4 for cooling the workpiece W is arranged to quickly cool the already treated workpiece part to a given temperature. However, this is not a necessary arrangement. Instead of the arrangement of a cooling stage ST4, a means can be used by which cooling air is blown in and by which cooling is carried out or natural air cooling can be performed.

Furthermore, the workpiece stage WS can be produced in one piece and control can be exercised such that the temperatures differ from section to section, or it can be formed from individual stages which each differ by different temperatures.

In the above described embodiment, the workpiece stage WS is made, for example, of four stages if it is formed from stages which each differ by their temperatures. Here, the respective stage is controlled to a different temperature. Temperature control in the boundary areas of the respective stage is simplified more if the workpiece stage WS is formed from individual stages.

If the workpiece stage WS is formed from different stages, step-like, clear differentiation of the temperatures of the boundary areas of the respective stage is simplified if the respective stage is arranged such that there is thermal insulation material between the stages. Ceramic or the like or even air can be used as the thermal insulation material. In the case of using air, the stages can be spaced apart from one another.

If a microwave excitation lamp or a blinking lamp which can be instantaneously operated or a lamp with little radiant heat is used during operation as the lamps LP1 to LP3, the shutter SH of the light irradiation part 11 can also be omitted.

When the resist is irradiated with UV radiation and when it is suddenly irradiated with intensive UV radiation, there are cases in which a phenomenon occurs which is called “bubble formation”, i.e., the phenomenon that air bubbles form within the resist. When bubbles form, the formed resist pattern is destroyed and etching cannot be carried out as desired. To prevent this, in the case of irradiation of the resist with UV radiation, the UV irradiation density first is kept small, and the illuminance is intensified after the air located within the resist has been released to the outside (for example, as described in Japanese patent publication HEI 5-74060, EP 0 233 333 A2).

Therefore, in accordance with the invention, control can also be exercised such that the illuminance of the lamp LP1 which corresponds to the carrier ST1 which is used for initial treatment, compared to the illuminance of the other lamps LP2 to LP3, is kept smaller, or that the illuminance of the lamp LP1 is first kept small and is increased after a given time has passed.

The illuminance of the lamps can be controlled by adjusting the lamp wattage. Furthermore, it can also be controlled by inserting a radiation attenuation shutter or a radiation attenuation filter between the lamps and the workpiece. The illuminance of the lamp LP1 is fixed at roughly 1/10 to 1/50 of the illuminance of the other lamps when the illuminance of lamp LP1 is made smaller than that of the other lamps LP2 to LP3 to prevent bubble formation of the resist.

In the above described embodiment, a case is described in which the lamps LP1 to LP3 and the stages ST1 to ST3 are arranged in respective correspondence to one another. However, the lamps need not always correspond to the stages.

In the above described embodiment, a case is described in which the workpiece W has been moved gradually and intermittently according to the width of the areas of the stages ST1 to ST3. However, the amount of transport of the workpiece need not always be matched to the width of the areas of the stages ST1 to ST3, but movement can be carried out only to the extent which corresponds, for example, to half of the width of the areas of the stages ST1 to ST3.

Action of the Invention

As was described above, in accordance with the invention, different areas of the workpiece stage are each set to a respective constant temperature. The workpiece stage need not quickly undergo a temperature increase. Therefore, a heater with a large output power need not be used. As a result, the power consumption can be reduced far more than in the conventional case.

Since the stage need not be subjected to a temperature drop from a high temperature quickly to a low temperature, the flow amount and pressure of the cooling water need not be increased. Therefore, the consumption of the device can be prevented from increasing.

What we claim is:

1. Process for curing a resist which has been applied to a workpiece, in which the resist is irradiated with UV radiation as it is heated, comprising the steps of transporting the workpiece in sections into respective areas with temperatures which increase in a direction of transport and irradiating the sections of the workpiece with UV radiation.

2. Process as claimed in claim 1, wherein, after transport into the areas which increase in temperature, the workpiece is transported into an area of low temperature for cooling.

3. Process as claimed in claim 2, wherein the workpiece is not irradiated with UV radiation in the cooling area with the lower temperature.

4. Process as claimed in claim 1, wherein the workpiece is a substrate for a display.

5. Device for curing a resist on a workpiece, in which the resist is irradiated with UV radiation as it is heated, comprising:
a light source part for irradiating the resist on the workpiece with UV radiation,
a workpiece stage having a support surface for seating the workpiece thereon, and
a transport means which transports the workpiece along the workpiece stage,
wherein the workpiece stage is divided into several areas which lie in succession in the direction of transport of the workpiece, each of which is smaller than the workpiece in the direction of transport, wherein a heating arrangement is provided which heats adjacent workpiece stage areas to different temperatures, and wherein a controller is provided which controls movement of the workpiece by the transport means in successive sections corresponding to the respective areas of the workpiece stage and irradiation of the sections of the workpiece with UV radiation.

6. Device as claimed in claim 5, wherein the heating arrangement is adapted to cause the temperature of adjacent workpiece stage areas to increase in the transport direction.

7. Device as claimed in claim 6, wherein the heating arrangement is adapted to cause the temperature of the workpiece stage area which is last in the transport direction to be lower than the temperature of the preceding workpiece stage area.

8. Device as claimed in claim 5, wherein the workpiece stage is comprised of several separated workpiece stage parts, each of which forms a respective workpiece stage area.

9. Device as claimed in claim 6, wherein a respective UV lamp for irradiating the resist on the workpiece is provided located opposite each workpiece stage area except for a one of the workpiece stage areas which is last in the transport direction.
